(19) United States
(12) Patent Application Publication
(10) Pub. No.: US 2024/0340596 A1
(43) Pub. Date: Oct. 10, 2024

(54) MEMS microphone

(71) Applicant: AAC ACOUSTIC TECHNOLOGIES (SHENZHEN) CO., LTD., Shenzhen (CN)

(72) Inventors: Yuwei Liu, Singapore (SG); Rui Zhang, Shenzhen (CN)

(21) Appl. No.: 18/399,736

(22) Filed: Dec. 29, 2023

Related U.S. Application Data
(63) Continuation of application No. PCT/CN2023/086242, filed on Apr. 4, 2023.

(51) Int. Cl. H04R 17/02; H04R 7/16

(52) U.S. Cl. CPC H04R 17/02; H04R 7/16; H04R 2201/003

(57) ABSTRACT

The present disclosure discloses a MEMS microphone including a substrate with a back cavity and a capacitive system arranged on the substrate, the capacitive system includes a back plate and a diaphragm opposite to the back plate, the diaphragm is located between the substrate and the back plate, the diaphragm is provided with a through hole, the back plate includes a body portion, an extension post extending from the body portion towards the substrate and penetrating the through hole, and a spacer connected to the extension post, the spacer is located between the diaphragm and the substrate, one end of the extension post is connected to the body portion of the back plate, the other end of the extension post is connected to the spacer. Compared with the related art, MEMS microphone disclosed by the present disclosure has a high reliability.

### FIELD OF THE PRESENT DISCLOSURE

The present disclosure relates to acoustic-electro conversion technologies, in particular to a micro-electro-mechanical system (MEMS) microphone.

### DESCRIPTION OF RELATED ART

With rapid developments of the mobile communication technology in recent years, mobile communication devices, such as portable phones, internet-enabled portable phones, personal digital assistants and other devices for communications in dedicated networks, are used more and more. A microphone, especially a MEMS microphone, is one of the most important components used in these devices.

A micro-electro-mechanical system (MEMS) microphone is an electroacoustic transducer produced by micro-mechanical technology, which has a small size, an excellent frequency response characteristic, a low noise, etc. As electronic devices are becoming smaller and thinner, MEMS microphones are increasingly and widely used in these devices.

A MEMS microphone in the related art includes a substrate with a back cavity and a capacitor system arranged on the substrate, the capacitor system includes a back plate and a diaphragm arranged opposite to the back plate. The diaphragm is located on a side of the back plate close to the substrate, and the diaphragm will come into contact with an edge of the substrate during vibration, especially when it is vigorously impacted, so that the strength and reliability of the MEMS microphone will be reduced.

Thus, it is necessary to provide a MEMS microphone to solve the problem.

### SUMMARY OF THE DISCLOSURE

An objective of the present disclosure is to provide a MEMS microphone with a high reliability.

In order to achieve the objective mentioned above, the present disclosure discloses a MEMS microphone including a substrate with a back cavity and a capacitive system arranged on the substrate, the capacitive system includes a back plate and a diaphragm opposite to the back plate, the diaphragm is located between the substrate and the back plate, the diaphragm is provided with a through hole, the back plate includes a body portion, an extension post extending from the body portion towards the substrate and penetrating the through hole, and a spacer connected to the extension post, the spacer is located between the diaphragm and the substrate, one end of the extension post is connected to the body portion of the back plate, the other end of the extension post is connected to the spacer.

Further, a projection of the spacer along a vibration direction of the diaphragm is at least partially located on the substrate.

Further, a width of the spacer is larger than that of the extension post.

Further, a width of the spacer is larger than an aperture of the through hole. Further, the extension post is integral with the body portion.

Further, the spacer is made of an insulating material.

Further, the extension post and spacer are hollow annular structures.

### BRIEF DESCRIPTION OF THE DRAWINGS

Many aspects of the exemplary embodiment can be better understood with reference to the following drawings. The components in the drawings are not necessarily drawn to scale, the emphasis instead being placed upon clearly illustrating the principles of the present disclosure.

FIG. 1 is an isometric view of a MEMS microphone in accordance with an exemplary embodiment of the present disclosure.

### DETAILED DESCRIPTION OF THE EXEMPLARY EMBODIMENTS

The present disclosure will hereinafter be described in detail with reference to exemplary embodiments. To make the technical problems to be solved, and technical solutions and beneficial effects of the present disclosure more apparent, the present disclosure is described in further detail together with the FIGURE and the embodiment. It should be understood the specific embodiment described hereby is only to explain the disclosure, not intended to limit the disclosure.

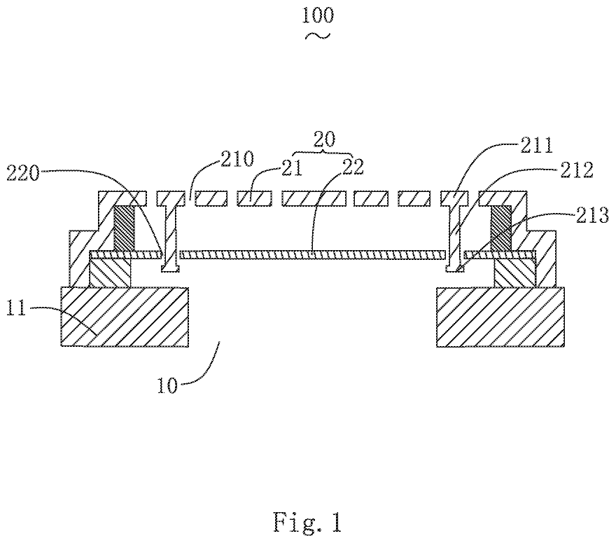

Referring to FIG. 1, this embodiment provides a MEMS microphone 100, including a substrate 11 with a back cavity 10 and a capacitive system 20 arranged on the substrate 11. The capacitive system 20 includes a back plate 21 and a diaphragm 22 opposite to the back plate 21, the diaphragm 22 is located on a side of the back plate 21 close to the substrate 11. When the sound pressure acts on the diaphragm 22, there is a pressure difference between the two sides of the diaphragm 22 facing the back plate 21 and the diaphragm 22 away from the back plate 21, so that the diaphragm 22 moves closer to the back plate 21 or away from the back plate 21, thereby causing a change in capacitance between the diaphragm 22 and the back plate 21 which will realize the conversion of the sound signal to the electrical signal.

The diaphragm is provided with a through hole 220, the through hole 220 could adjust the damping of the diaphragm 22. The back plate 21 includes a body portion 211, an extension post 212 extending from the body portion 211 towards the substrate 11 and penetrating the through hole 220, and a spacer 231 connected to the extension post 212. The body portion 211 is provided with a plurality of back plate holes 210. One end of the extension post 212 is connected to the body portion 211 of the back plate 21, the other end of the extension post 212 is connected to the spacer 231. In addition, the spacer 213 is located between the diaphragm 22 and the substrate 11.

A projection of the spacer 213 along a vibration direction of the diaphragm 22 is at least partially located on the substrate 11. When the diaphragm 22 is operating under acoustic pressure, the diaphragm 22 moves upward, and this structure of the back plate 21 does not affect the degree of freedom of the diaphragm 22, so that there is no loss of the sensitivity of the diaphragm 22; and in the event that the MEMS microphone 100 is dropped or vigorously impacted, the spacer 213 of the back plate 21 protects the diaphragm 22 so that the diaphragm 22 does not come into direct contact with the edges of the substrate 11, which strengthens the diaphragm 22 and alleviates any damage to the diaphragm 22 when it comes into contact with the substrate 11.

A width of the spacer 213 is larger than a width of the extension post 212 and larger than an aperture of the through hole 220, which can make the diaphragm 22 contact with the spacer 213 or the spacer 213 contact with the substrate 11 when the amplitude of the diaphragm 22 is too large, and play a role of protecting the diaphragm 22.

The extension post 212 may be an integral structure with the body portion 211, i.e., the nitride back plate is formed deposition directly, and the spacer 213 is made of an insulating material. Alternatively, in this embodiment, the extension post 212 and the spacer 213 are hollow annular structures, and in other embodiments, the extension post and the spacer may be a number of separate structures.

Compared with the related art, by providing a spacer 213 connected to the body portion 211 of the back plate 21 between the diaphragm 22 and the substrate 11, the direct contact between the diaphragm 22 and the edge of the substrate 11 is avoided, the strength of the diaphragm 22 is strengthened, and the effect of reliability of the product can be improved.

It is to be understood, however, that even though numerous characteristics and advantages of the present exemplary embodiment have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms where the appended claims are expressed.

What is claimed is:

1. A MEMS microphone, comprising:
a substrate with a back cavity; and
a capacitive system arranged on the substrate, comprising a back plate and a diaphragm opposite to the back plate, the diaphragm located between the substrate and the back plate; wherein
the diaphragm is provided with a through hole, the back plate comprises a body portion, an extension post extending from the body portion towards the substrate and penetrating the through hole, and a spacer connected to the extension post, the spacer is located between the diaphragm and the substrate, one end of the extension post is connected to the body portion of the back plate, the other end of the extension post is connected to the spacer.

2. The MEMS microphone as described in claim 1, wherein a projection of the spacer along a vibration direction of the diaphragm is at least partially located on the substrate.

3. The MEMS microphone as described in claim 1, wherein a width of the spacer is larger than that of the extension post.

4. The MEMS microphone as described in claim 1, wherein a width of the spacer is larger than an aperture of the through hole.

5. The MEMS microphone as described in claim 1, wherein the extension post is integral with the body portion.

6. The MEMS microphone as described in claim 1, wherein the spacer is made of an insulating material.

7. The MEMS microphone as described in claim 1, wherein the extension post and spacer are hollow annular structures.
